(19) United States
(12) Patent Application Publication
(10) Pub. No.: US 2009/0113095 A1
(43) Pub. Date: Apr. 30, 2009

(54) COMPUTER WITH COMPOUND AUDIO INTERFACE

(75) Inventors: CHANG-CHUN LIU, Shenzhen (CN); XIAO-LIN GAN, Shenzhen (CN); YU-KUANG HO, Taipei Hsien (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 11/942,726

(22) Filed: Nov. 20, 2007

(30) Foreign Application Priority Data
Oct. 24, 2007 (CN) 200710202242.9

(51) Int. Cl. G06F 13/00

(52) U.S. Cl. 710/104

(57) ABSTRACT

An exemplary computer with compound audio interface includes a chassis, a USB interface arranged in the chassis, an audio interface arranged in the chassis, and a switch arranged in the chassis. The USB interface includes two signal terminals and a ground terminal. The audio interface includes two audio signal terminals and a ground terminal, wherein the audio signal terminals and the ground terminal of the audio interface are connected to the signal terminals and the ground terminal of the USB interface via the switch respectively. The audio signals received by the USB interface can be transmitted to an audio system in the chassis via the audio interface.

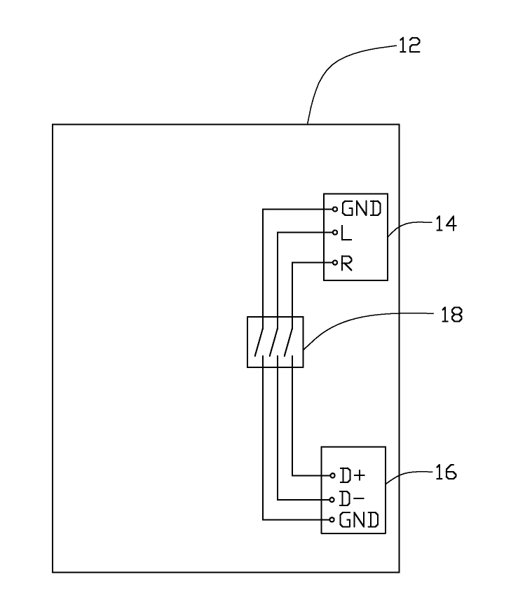

### BACKGROUND

1. Field of the Invention

The present invention relates to computer, and particularly to a computer with compound audio interface.

2. Description of Related Art

Conventionally, many different interfaces are arranged in a computer chassis, for example USB interface, VGA interface, audio interface, and so on. These interfaces are arranged in the computer chassis for different purpose and each has a special standard. For example, the USB interface allows peripherals to be connected using a single standardized interface socket and improves plug-and-play capabilities by allowing devices to be connected and disconnected without rebooting the computer.

But the USB interface is not coupled to an audio system of the computer, that is, when the USB interface is coupled with an audio device, the audio signal transmitted by the audio device will not be received by the audio system of the computer.

### SUMMARY

An exemplary computer with compound audio interface includes a chassis, a USB interface arranged in the chassis, an audio interface arranged in the chassis, and a switch arranged in the chassis. The USB interface includes two signal terminals and a ground terminal. The audio interface includes two audio signal terminals and a ground terminal, wherein the audio signal terminals and the ground terminal of the audio interface are connected to the signal terminals and the ground terminal of the USB interface via the switch respectively.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is an isometric view of a computer with compound audio interface in accordance with the present invention.

### DETAILED DESCRIPTION

Referring to the drawing, a computer with compound audio interface in accordance with an embodiment of the present invention includes a chassis 12, a USB interface 16 arranged in the chassis 12, an audio interface 14 arranged in the chassis 12, and a switch 18 arranged in the chassis 12. The USB interface 16 includes two signal terminals D+ and D−, and a ground terminal GND. The audio interface 14 includes two audio signal terminals R and L, and a ground terminal GND. The audio signal terminals R and L and the ground terminal GND of the audio interface 14 are connected to the signal terminals D+ and D− and the ground terminal GND of the USB interface 16 via the switch 18 respectively.

The switch 18 is a three-pole three-throw switch, the audio signal terminals R and L and the ground terminal GND of the audio interface 14 are connected to the throws of the switch 18, and the signal terminals D+ and D− and the ground terminal GND of the USB interface 16 are connected to the poles of the switch 18.

Therefore, when the USB interface 16 is coupled with a USB audio device, audio signals received by the USB interface 16 will be transmitted to an audio system in the chassis 12 via the audio interface 14 by turning on the switch 18.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer with compound audio interface comprising:
a chassis;
a USB interface arranged in the chassis, having two signal terminals and a ground terminal;
an audio interface arranged in the chassis, having two audio signal terminals and a ground terminal; and
a switch arranged in the chassis,
wherein the audio signal terminals and the ground terminal of the audio interface are coupled with the signal terminals and the ground terminal of the USB interface via the switch respectively.

2. The computer as claimed in claim 1, wherein the switch is a three-pole three-throw switch, the audio signal terminals and the ground terminal of the audio interface are connected to the throws of the switch, and the signal terminals and the ground terminal of the USB interface are connected to the poles of the switch.
